(19) United States
(12) Patent Application Publication
(10) Pub. No.: US 2003/0147250 A1
(43) Pub. Date: Aug. 7, 2003

(54) Front license plate light

(76) Inventor: David Allen Grant, Castaic, CA (US)

Correspondence Address: David Grant, 30471 Star Canyon Place, Castaic, CA, 91384, US

(21) Appl. No.: 10/359,861

(22) Filed: Feb. 7, 2003

Related U.S. Application Data
(60) Provisional application No. 60/354,381, filed on Feb. 7, 2002.

(51) Int. Cl. B60Q 1/56

(52) U.S. Cl. 362/497; 362/543

(57) ABSTRACT

A front license plate light attachable on the front bumper of an automobile which comprises generally a lamp or lamps shining on the front license plate when the engine is in operation whether the license plate is mounted on the front bumper or another part of the motor vehicle.

### CROSS REFERENCE TO RELATED APPLICATIONS

U.S. Pat. No. 5,150,960 Sep. 29, 1992 Appl. No. 802,801 Filed Dec. 6, 1991 Rear license plate illumination

U.S. Pat. No. 5,177,889 Jan. 12, 1993 Appl. No. 616282 Filed Nov. 20, 1990 Auto license plate's illumination structure

U.S. Pat. No. 6,471,379 Oct. 29, 2002 Appl. No. 813,662 Filed Mar. 21, 2001 Waveguide illumination assembly for an automobile license plate

### BACKGROUND OF INVENTION

The present invention relates to automobile apparatus, more articularly to a front license plate light attachable to a position above, beside or below the front license plate of any motor vehicle.

A light on the front license plate would illuminate the front licnese plate to assist in the identification of a vehicle for individuals, public entities and law enforcement personnel, as it is approaching a busy intersection equipped with or without overhead cameras. In many major intersections throughout the United States and other countries cameras are being installed for public protection purposes. However, in many more cases than not, no such apparatus exists.

This invention is a new device. It builds upon related concepts of public safety with respect to a rear license plate light. Every motor vehicle is required by law to have an illuminated rear license plate, and most states require a front license plate, but not one motor vehicle is equipped with a front license plate light. A lighted front license plate would enhance public safety for similar reasons connected with the lighting of any rear license plate.

### BRIEF SUMMARY OF THE INVENTION

The front license plate light includes a single light and/or multiple sources that operates with the headlight switch so the front license plate is illuminated when the vehicle's engine is actually on. A light on the front license plate of any motor vehicle would aid peace officers, public entities, or citizens to identify a vehicle violating traffic laws, such as running a red light, fleeing the scene of an accident or any other violation of law, should the natural light of day be too dim, such as at dusk, or night time.

### BRIEF DESCRIPTION OF THE DRAWINGS

FIG. 1 is a front perspective view of an automobile with a front license plate light.

FIG. 2 is a closer view of the front bumper area of an automobile with a front license plate light.

FIG. 3 is a front view of the front license plate mounted on the front bumper with two individual lights mounted above the front license plate of an automobile.

### DETAILED DESCRIPTION

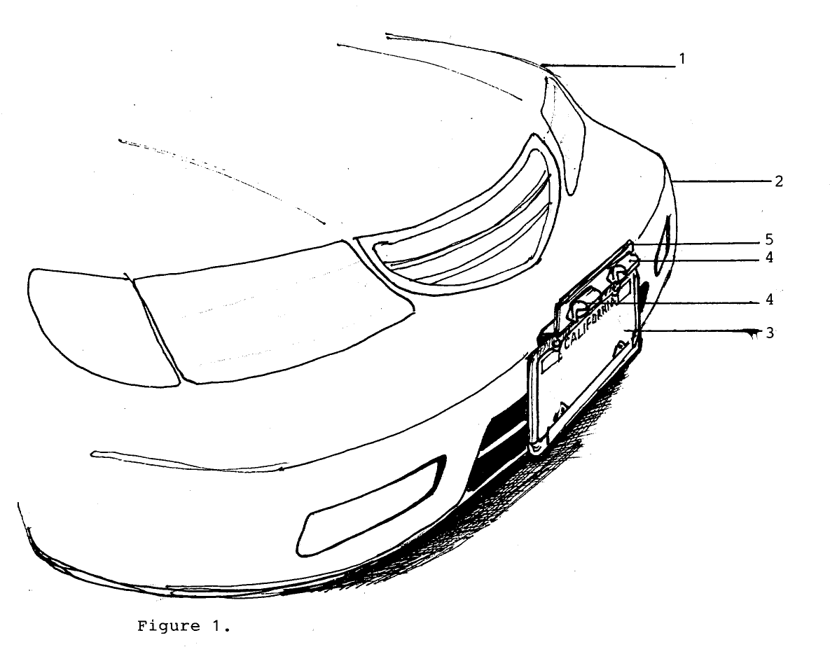

FIG. 1. is a perspective view of an automobile (1) with a front license plate light (4) made according to the present invention. The vehicle front license plate (3) is illuminated by the device (4) is shown located just above the front license plate (3) mounted on a metal bracket (5) on the front bumper (2). Although not shown, the light is illuminated by the headlight electrical harness as a day and night time running lights so the front license plate light (4) is on as long as the engine is running.

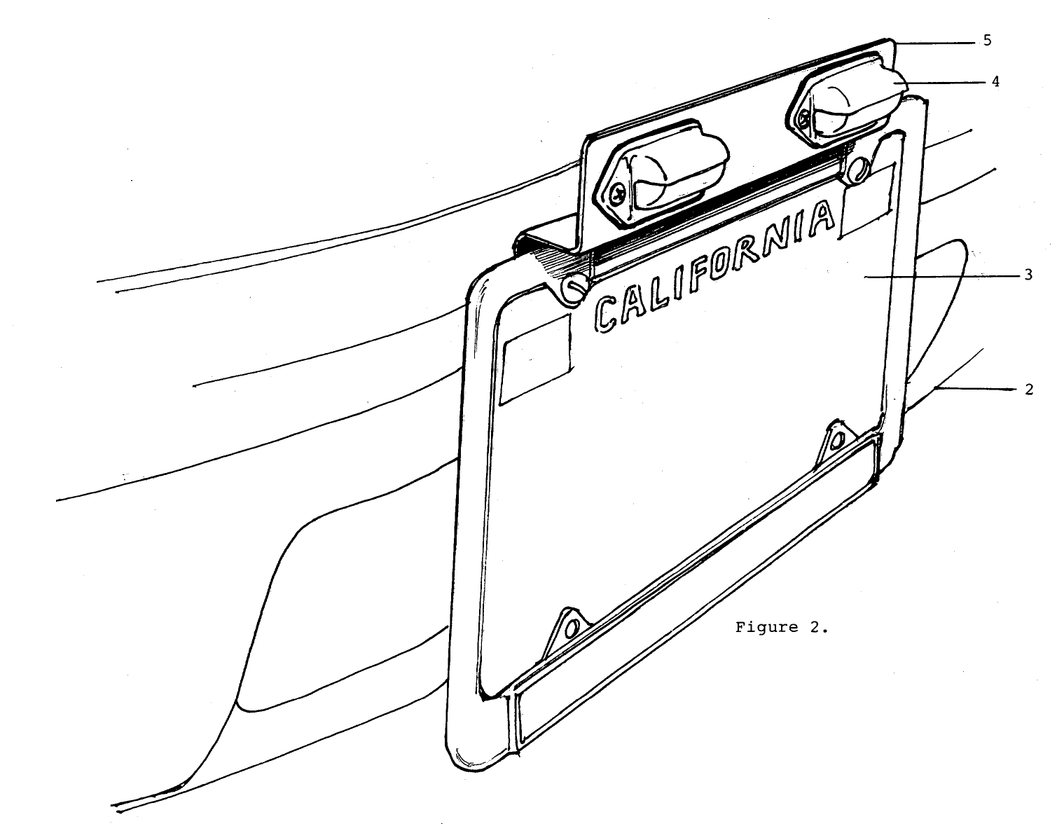

FIG. 2. is a closer view of the front bumper (2) with a front license plate light (4). One or more lights (4) are mount on a bracket (5) so as to illuminate the license plate (3) as long as the engine of the automobile (1) is running.

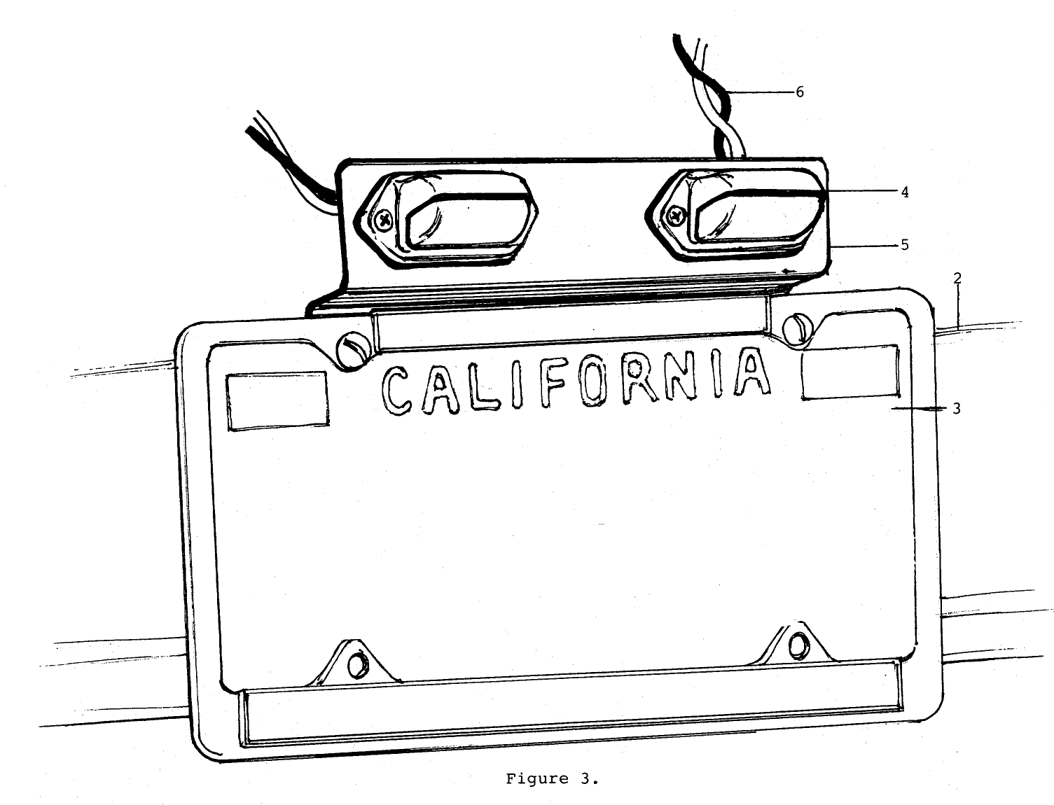

FIG. 3. is a front view of the front license plate (3) mounted on the front bumper (2) with two individual lights (4) mounted above the front license plate (3) of an automobile (1). The front license plate light (4) is powered by wires (6) connected to the headlight harness in such a way as to power the front license plate light as long as the engine is running.

I claim:

1. A front license plate light which is attatched to the front bumper of an automobile or any other part of the automobile so the light shines on the front license plate comprising:
a. a generally rectangular lamp mounted above the front license plate of an automobile to shine on the front license plate of an automobile,
b. configured as two separate lamps mounted above the front license plate of an automobile to shine on the front license plate of an automobile,
c. configured as two separate lamps mounted on each side of the front license plate of an autombile to shine on the front license plate of an automobile,
d. configured as a lamp mounted below the license plate of an automobile to shine on the front license plate of an automobile.
